(19) United States
(12) Patent Application Publication
(10) Pub. No.: US 2026/0302278 A1
(43) Pub. Date: Oct. 1, 2026

(54) INDIRECT THERMAL MANAGEMENT SYSTEM FOR ELECTRIC VEHICLE AND ELECTRIC VEHICLE INCLUDING SAME

(71) Applicant: American Honda Motor Co., Inc., Torrance, CA (US)

(72) Inventors: Randy CHEUNG, Ypsilanti, MI (US); Phillip MILLWARD, Plymouth, MI (US); Gyula TOTH, Northville, MI (US); Istvan VINZCE, Plymouth, MI (US); Peter ` KURUCZ, Plymouth, MI (US)

(21) Appl. No.: 19/094,871

(22) Filed: Mar. 29, 2025

(51) Int. Cl. H01M 8/04007; B60L 7/06; B60L 50/51; B60L 50/75; H01M 8/04029

(52) U.S. Cl. CPC H01M 8/04067; B60L 7/06; B60L 50/51; B60L 50/75; H01M 8/04029; B60L 2200/36; B60L 2210/10; B60L 2210/40

(57) ABSTRACT

An electric vehicle can include an indirect thermal management system, a plurality of fuel cell units, at least one electric motor and a high voltage battery system. The indirect thermal management system can include a plurality of heat exchangers configured to be in fluid communication with and absorb heat produced by the fuel cell units, a plurality of load resistors, a plurality of common radiators, and a plurality of high voltage pumps. Each of the load resistors is in fluid communication with at least a respective one of the heat exchangers and each of the common radiators is in fluid communication with a respective one of the load resistors. Each of the high voltage pumps is configured to circulate coolant among at least a respective one of the heat exchangers, the respective one of the common radiators, and a respective one of the load resistors.

### BACKGROUND

The disclosed subject matter relates to a fuel cell electric vehicle. More particularly, the disclosed subject matter relates to methods and apparatus for transferring waste heat generated by a fuel cell system of an electric vehicle.

An electric vehicle can include a battery assembly that is connected to one or more electric motors that drive one or more wheels of the vehicle. The battery assembly can be recharged by an internal combustion engine that is mounted on the vehicle (also known as a hybrid electric vehicle) and/or by connecting the battery to an external source of electric power. In these configurations, the electric vehicle ultimately relies on fossil fuels as the source of electric power. The electric vehicle that relies on fossil fuels might not be considered to be carbon-neutral even though the electric vehicle itself might not emit carbon monoxide during its use.

As an alternative to a hybrid electric vehicle or a battery electric vehicle, an electric vehicle can include a fuel cell system that generates electric power for charging the battery assembly. The fuel cell system can include a plurality of fuel cells (also referred to as a fuel cell stack) stacked in series to provide a desired voltage and/or stacked in parallel to provide desired current. Each fuel cell can include an anode, a cathode and electrolyte sandwiched between the anode and the cathode. There are many different types of electrolytes that can be used with the fuel cell. A proton exchange member (“PEM”) fuel cell is a fuel cell that includes polymer electrolyte membrane, uses gaseous hydrogen as a fuel, and combines the hydrogen with oxygen from the ambient environment to produce electrons, water and heat. Thus, a fuel cell system can be carbon neutral.

### SUMMARY

Some embodiments are directed to an indirect thermal management system for an electric vehicle including a plurality of fuel cell units, at least one electric motor and a high voltage battery system. The indirect thermal management system can include a plurality of heat exchangers, a plurality of load resistors, a plurality of common radiators, and a plurality of high voltage pumps. The heat exchangers can be configured to be in fluid communication with and absorb heat produced by the fuel cell units. Each of the load resistors can be in fluid communication with at least a respective one of the heat exchangers and each of the common radiators can be in fluid communication with a respective one of the load resistors. Each of the high voltage pumps can be in fluid communication with a respective one of the common radiators and configured to circulate coolant among at least a respective one of the heat exchangers, the respective one of the common radiators, and a respective one of the load resistors.

Some embodiments are directed to an indirect thermal management system for an electric vehicle including a battery pack, at least one driven wheel, and at least one electric motor in electrical communication with the battery pack and configured to drive the driven wheel. The indirect thermal management system can include a first fuel cell unit, a first heat exchanger, and a first high temperature cooling circuit. The first fuel cell unit that can include a fuel cell stack and a balance of plant. The first heat exchanger can be in fluid communication with the fuel cell stack and isolated from the balance of plant. The first high temperature cooling circuit that can be isolated from the first fuel cell unit such that coolant flowing through the fuel cell stack of the first fuel cell unit is isolated from coolant flowing through the first high temperature cooling circuit. The first high temperature cooling circuit can include a first load resistor, a first radiator and a first pump. The first load resistor can be in fluid communication with the first heat exchanger and configured to convert electrical energy into heat. The first radiator can be in fluid communication with the first load resistor and configured to be in fluid communication with ambient air outside of the electric vehicle. The first pump can be in fluid communication with the first radiator and the first heat exchanger, and configured to circulate coolant among the first heat exchanger, the first load resistor, and the first radiator.

Some embodiments are directed to an indirect thermal management system for an electric vehicle including a battery pack, at least one driven wheel, and at least one electric motor in electrical communication with the battery pack and configured to drive the driven wheel. The indirect thermal management system can include a first fuel cell, a second fuel cell, a third fuel cell, a plurality of heat exchangers, a plurality of load resistors, a plurality of radiators and a plurality of high voltage pumps. The first fuel cell unit can include a first fuel cell stack and a first balance of plant, the second fuel cell unit can include a second fuel cell stack and a second balance of plant, and the third fuel cell unit can include a third fuel cell stack and a third balance of plant. The plurality of heat exchangers can be configured to be in fluid communication with and absorb heat produced by the first fuel cell stack, the second fuel cell stack, and the third fuel cell stack. Each of the load resistors can be in fluid communication with at least a respective one of the heat exchangers, and each of the radiators i can be s in fluid communication with a respective one of the load resistors. Each of the high voltage pumps can be in fluid communication with a respective one of the radiators and configured to circulate coolant among at least a respective one of the heat exchangers, the respective one of the radiators, and a respective one of the load resistors.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a side view of an electric vehicle that includes a thermal management system made in accordance with principles of the disclosed subject matter.

FIG. 2 is a perspective view of a portion of the electric vehicle of FIG. 1.

FIG. 3 is front plan view of the thermal management system of the electric vehicle of FIG. 1.

FIG. 4 is a schematic illustration of the thermal management system of the electric vehicle of FIG. 1.

FIG. 5 is a schematic illustration of a thermal circuit for a battery pack of the electric vehicle of FIG. 1.

FIG. 6 is a schematic illustration of a power distribution system of the electric vehicle of FIG. 1.

FIG. 7 is a front perspective view of the thermal management system of the electric vehicle of FIG. 1.

FIG. 8 is a rear perspective view of the thermal management system of the electric vehicle of FIG. 1.

FIG. 9 is a plan view of an enlarged portion of FIG. 8 with a pair of load resistors added.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

An electric vehicle can be a passenger vehicle, a bus, a commercial transport vehicle, a construction vehicle, a boat, a spacecraft, or an aircraft. A commercial transport vehicle can be a van, a truck, or a tractor-trailer (also referred to as a semi-trailer truck, a trailer truck, or a semi) that is configured to transport products from location to location. Tractor-trailers can be advantageous for carrying large quantities of products or heavy products over short distances and long distances. A conventional tractor-trailer can include a compression-ignition internal combustion engine. Not only does the engine emit carbon compounds and undesirable compounds of nitrogen, but also particulates such as soot. Thus, it can be advantageous to provide a tractor-trailer with at least one electric motor and a battery pack that powers the electric motor(s).

In order to provide an advantageous range for an electric vehicle, the battery should have a large energy storage capacity. However, current-technology batteries are relatively heavy and the increased mass of the battery pack could adversely impact the travel range between charging events. A fuel cell system could overcome this potential disadvantage by charging the battery pack 15 while the electric vehicle is traveling, thus extending the driving range of the electric vehicle.

The fuel cell system can increase the range of the electric vehicle as compared to a plug-in battery-powered electric vehicle. However, a single fuel cell (also referred to as a fuel cell unit) that can meet the desired charging rate might exceed the space available on/in the electric vehicle or exceed the desired weight for the electric vehicle. Additionally, or alternatively, the support equipment such as but not limited to, an air supply system and a cooling system, might exceed the space available on/in the electric vehicle or exceed the desired weight for the electric vehicle. Conversely, a single fuel cell unit might not meet the desired charging rate for charging the battery pack. Thus, it might be advantageous to provide the electric vehicle with a plurality of fuel cell units.

A plurality of fuel cell units can produce a relatively large amount of waste heat. Further, the components and systems that support the operation of the fuel cell units and/or distribute the power output by each of the fuel cell units can be sensitive to relatively high temperatures and/or produce additional waste heat. Thus, it can be advantageous to provide a fuel cell powered electric vehicle with a thermal management system that can efficiently transfer the waste heat to the ambient air that is outside of the electric vehicle.

Each of the fuel cell units can include a fuel cell stack and a balance of plant (also referred to as BOP). The fuel cell stack can be configured to produce electricity from a flow of hydrogen gas and oxygen passing through the fuel cell stack. The BOP can include structures and systems that support the operation of the fuel cell stacks such as, but not limited to, filter(s), a compressor, an intercooler, a humidifier, valve(s), and a water separator. The BOP can include structure(s) that support, mount and/or house the fuel cell stacks and the remainder of the BOP.

The fuel cell stack can produce a relatively large amount of waste heat. The fuel cell stack can be sheltered from the ambient air that is outside of the electric vehicle by a housing or enclosed compartment to protect the fuel cell stack from adverse weather conditions, debris, dust and/or undesirable fluids. Thus, it can be advantageous to place the fuel stack in fluid communication with a heat exchanger that is exposed to the ambient air outside of the electric vehicle and circulate coolant through the fuel cell stack and the heat exchanger.

Other structure(s) and/or system(s) of the electric vehicle might generate waste heat that is desirable for transfer to the ambient air that is outside of the electric vehicle. Some of these other structure(s) and/or system(s) can include ion leaching materials that can introduce ions into the coolant and increase the electric conductivity of the coolant. Electrical conductivity in the coolant flowing through the fuel cell stack can adversely impact the operation of the fuel cell stack. Thus, it can be desirable to isolate the ion leaching materials from the fuel cell stack.

Further, the desired operating temperature range for the fuel cell stack may be incompatible with the desired operating temperature range of other structure(s) and/or system(s) of the electric vehicle. Thus, it can be advantageous to provide a thermal management system that has at least two separate coolant circuits that separates the fuel cell stack from structure(s) and/or system(s) that rely on ion leaching materials and have incompatible desired operating temperatures. However, space constraints and airflow rates can limit the surface area of the vehicle 1 that is available to transfer heat from the fuel cells stacks 46, and other heat generating structure(s) and/or system(s) of the vehicle 1, to the ambient air. Thus, it can be difficult to provide each fuel cell stack 46 with a fully isolated cooling circuit that is in direct fluid communication with the outside air.

Thus, it can be advantageous to provide a thermal management system that is optimized for weight, volume, electric power consumption, and heat transfer capacity and also reduces or prevents ion leaching into the coolant flowing through the fuel cell stack.

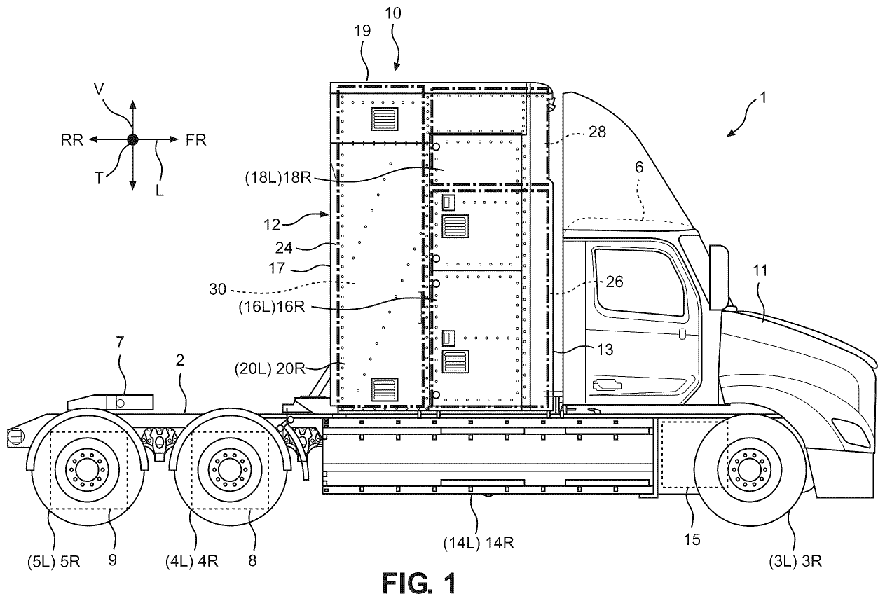

FIG. 1 illustrates an embodiment of an electric vehicle 1 (hereinafter “vehicle”) made in accordance with principles of the disclosed subject matter. The vehicle 1 can extend in a longitudinal direction L, a transverse direction T and a vertical direction V. The longitudinal direction L includes a front direction FR and a rear direction RR and the transverse direction includes a left direction LT and a right direction RT. The vehicle 1 shown in FIG. 1 can be specialized for use as a commercial transport vehicle.

The vehicle 1 can include a main power system 10, a chassis 2, a pair of front wheels 3L, 3R and a front pair of dual rear wheels 4L, 4R, a rear pair of dual rear wheels 5L, 5R, a cab 6, a fifth wheel 7, and a hood 11. The left-side wheels 3L, 4L, 5L are obstructed from view and can be the same as the right-side wheels 3R, 4R, 5R. The wheels 3L, 3R, 4L, 4R, 5L, 5R can be connected to and suspended from the chassis 2 in any appropriate manner. The chassis 2 can include a pair of frame rails that extend in the longitudinal direction L from a location in front of the front wheels 3L, 3R to a location behind the rear pair of dual wheels 5L, 5R. The frame rails can be spaced apart from each other in the transverse direction T. The cab 6 and the fifth wheel 7 can be mounted on the chassis 2 by any appropriate manner. The main power system 10 can be mounted on the chassis 2 at a location that is adjacent to the cab 6 and in front of the front pair of dual rear wheels 4L, 4R in the longitudinal direction L. The main power system 10 can be connected to the chassis 2 by any appropriate manner.

The vehicle 1 can include a first electric motor 8 that drives the front pair of dual rear wheels 4L, 4R and a second electric motor 9 that drives the rear pair of dual rear wheels 5L, 5R. The electric motors 8, 9 are schematically illustrated in phantom. The main power system 10 can generate, store, and distribute electric power to the electric motors 8, 9 and supply electric power generated by either of the electric motors 8, 9 to a battery pack 15 of the main power system 10. Each of the electric motors 8, 9 can be integrated with a differential gear assembly and can be referred to as an E-axle.

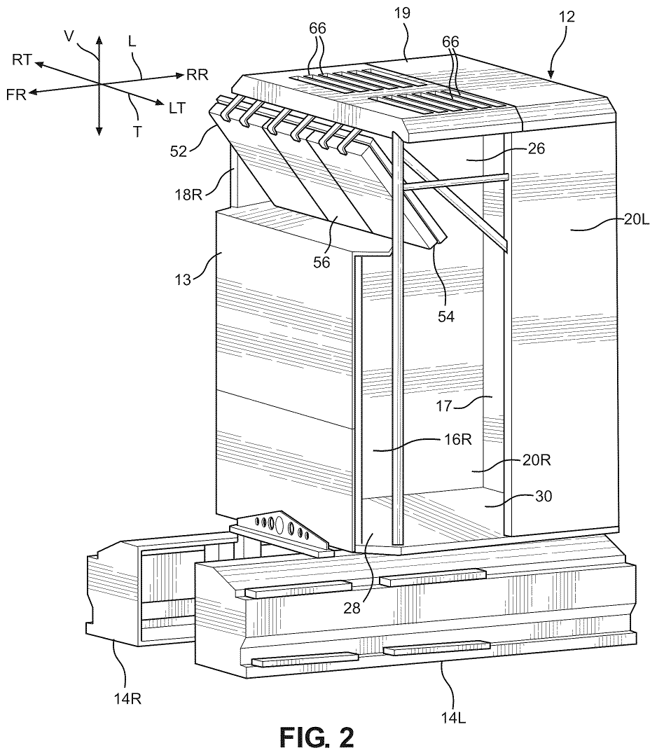

The main power system 10 can include a main housing 12 and a pair of saddle enclosures 14L, 14R. The left-side saddle enclosure 14L is shown in FIG. 2 and obstructed from view in FIG. 1. The main housing 12 can be mounted on the chassis 2 at a location that is behind the cab 6 in the longitudinal direction L and in front of the front pair of rear dual wheels 4L, 4R in the longitudinal direction L. The main housing 12 can extend along the top of the chassis 2 in the longitudinal direction L and the transverse direction T. The main housing 12 can extend away from the chassis in the vertical direction V.

The main power system 10 can be include a fuel cell system 22 (also referred to as an FCS or as an FCS system) that generates electricity for powering the vehicle 1 and a hydrogen storage system 24 (also referred to as a HSS or as a HSS system) for storing a supply of hydrogen gas for the fuel cell system 22. The FCS 22 and the HSS 24 are schematically illustrated in phantom.

The main power system 10 can include a battery pack 15 that includes a plurality of battery cells. Each of the battery cells can store and discharge electricity. The battery pack 15 can be mounted between the frame rails of the chassis 2. The battery pack 15 can be in electrical communication with the FCS 22 and the electric motors 8, 9. The battery pack 15 is obscured from view in FIG. 1 and shown in phantom.

The main housing 12 can contain the FCS 22 and the HSS 24 and shelter these systems 22, 24 from the ambient environment. The main housing 12 can include a plurality of access panels 13, 16L, 16R, 17, 18L, 18R, 19, 20L, 20R. The left-side panels 16L, 18L, 20L are obstructed from view and can be a mirror copy of the right-side panels 16R, 18R, 20R. The access panels 16L, 16R, 17, 18L, 18R, 20L, 20R can be removably or pivotally mounted to provide convenient access to the components and systems of the main power system 10. The front access panel 13 can cover a front side of the main housing 12 that faces the rear side of the cab 6. The lower access panels 16L,16R can selectively open and close a fuel cell compartment 26 illustrated in phantom. The upper access panels 18L, 18R can selectively open and close a heat exchanger compartment 28 and an upper portion of the fuel cell compartment 26. The compartments 26, 28 are schematically illustrated in phantom. The rear panel 17 and the fuel access panels 20L, 20R can selectively open and close a hydrogen compartment 30 that is schematically illustrated in phantom. The rear panel 17 can extend along the entirety of the rear side of the main housing 12. The top panel 19 can cover at least a portion of the top side of the main housing 12 and can include an exhaust outlet for heat exchangers housed in the heat exchanger compartment 28.

The saddle enclosures 14L, 14R can be connected to and extend along a respective one of the frame rails of the chassis 2 in the longitudinal direction L and away from the respective frame rail in the vertical direction V. The saddle enclosures 14L, 14R can protect respective portions of the main power system 10 from objects, dirt, debris and fluids. The saddle enclosures 14L, 14R can be located between the left front wheel 3L, 3R and the forward dual wheels 4L, 4R. The saddle enclosures 14L, 14R can extend away from the respective frame rail in the transverse direction T. The saddle enclosures 14L, 14R can be connected to the chassis 2 by any appropriate manner such as, but not limited to, threaded fasteners, clamps, straps, clips, hinges, or any combination of these attachment devices.

The FCS 22 can be housed within the fuel cell compartment 26 and include at least one fuel cell stack and the components and systems that supply hydrogen and oxygen to the fuel cell stack, control the electrical power output, collect and remove the water produced by the fuel cell stack, circulate cooling water for the fuel cell stack, and humidify the ambient air prior to supplying the ambient air to the fuel cell stack.

The HSS 24 can be in fluid communication with FCS 22 and housed within the hydrogen compartment 30. The hydrogen compartment 30 can also be referred to as a fuel storage compartment. Referring to FIG. 2, the HSS 24 can include at least one tank mounted inside the hydrogen compartment 30 of the main housing 12. The tank(s) can store a predetermined amount of hydrogen gas for the FCS 22.

FIG. 2 shows the main housing 12 and the saddle tanks 14L, 14R with the FCS 22 and the HSS 24 omitted for clarity and simplicity of the drawing. The compartments 26, 28, 30 can be predetermined volumes of the space inside of the main housing 12 without structural dividers separating the compartments 26, 28, 30 from each other. In alternate embodiments, the main housing 12 can include one or more walls that separates any one of the compartments 26, 28, 30 from any other one or other two of the compartments 26, 28, 30.

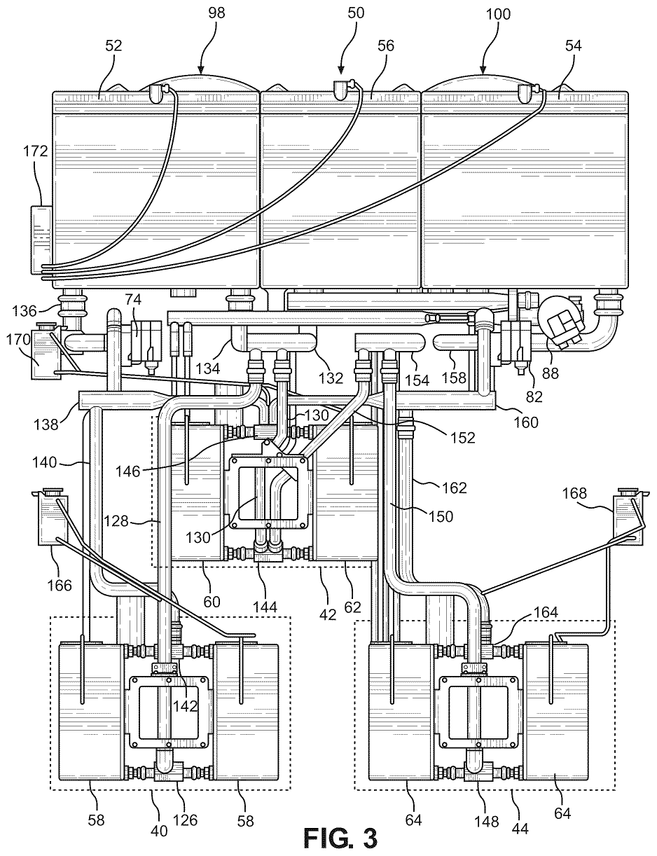

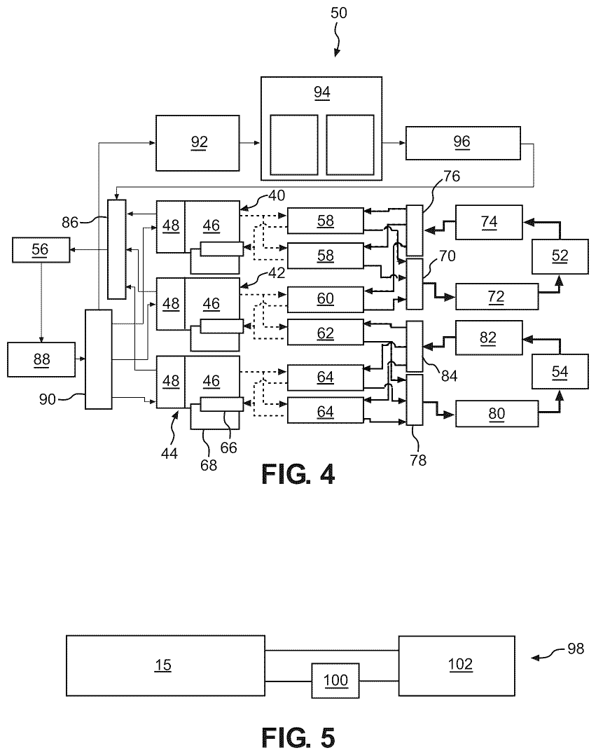

Referring to FIGS. 3 and 4, the FCS 22 include three fuel cell units 40, 42, 44. The fuel cell units 40, 42, 44 are shown schematically in phantom in FIG. 3 for clarity and simplicity of the drawing. Referring to FIG. 4, each of the fuel cell units 40, 42, 44 can include a fuel cell stack 46 and a BoP 48. The BoP 48 can include structures and systems that support the operation of the fuel cell stacks such as, but not limited to, filter(s), a compressor, an intercooler, a humidifier, valve(s), and a water separator. The BoP 48 can include structure(s) that support, mount and/or house the fuel cell stacks 46 and the remainder of the BoP 48.

Referring to FIGS. 2-4, collectively, the electric vehicle 1 can include an indirect thermal management system 50 that is a unified cooling system capable of rejecting the heat output by the three fuel cell units 40, 42, 44 as well as implementation of related hardware through a plurality of common radiators 52, 54, 56. The system 50 can be configured to transfer a predetermined thermal load to the ambient air at a predetermined maximum ambient temperature if the vehicle 1 is stationary (i.e., the vehicle speed is 0 m/s). The predetermined thermal load can be referred to as waste heat and can be a combined waste heat produced by the fuel cell units 40, 42, 44 together.

Electrical conductivity in the coolant flowing through the fuel cell stacks 46 can adversely impact the operation of the fuel cell stacks 46. To minimize or limit the adverse effect(s) caused by ion leaching, the fuel cell units 40, 42, 44 can be cooled using an isolated coolant that includes de-ionized water and glycol. Other structure(s) and/or system(s) of the vehicle 1 might generate waste heat that is desirable for transfer to the ambient air. However, some of these other structure(s) and/or system(s) can include ion leaching materials. Thus, it is desirable to isolate the ion leaching materials from the fuel cell stacks 46.

The common radiators 52, 54 56 can provide a desired heat transfer rate with the ambient air outside the vehicle 1 so that all of the waste heat producing structures and systems of the vehicle 1 can be cooled to desired levels. To minimize ion leaching into the coolant flowing through the fuel cell stacks 46, the indirect thermal management system 50 (referred to hereinafter as system 50) can include a plurality of heat exchangers 58, 60, 62, 64 that isolate the isolation coolant from the remainder of the system 50 and allow heat transfer out of the isolation coolant without introducing any ion leaching materials that pose risks to the isolation coolant conductivity. The system 50 can also include structures such as, but not limited to, conduits and connections that are fabricated from material(s) such as, but not limited to, AISI grade 316 stainless steel and high purity silicone that can contribute to the prevention of ion leaching or limiting ion leaching below a desired level.

Referring to FIG. 2, the system 50 can be installed to the main housing 12 with the common radiators 52, 54, 56 located in the heat exchanger compartment 28 and the heat exchangers 58, 60, 62, 64 located in the fuel cell compartment 26. The common radiators 52, 54, 56 can be inclined with respect to longitudinal direction L and the vertical direction V of the vehicle 1 in order to reduce the overall height of the vehicle 1 in the vertical direction V. The common radiators 52, 54, 56 can be arrayed side-by-side along the transverse direction T of the vehicle 1 with the third common radiator 56 located between the first common radiator 52 and the second common radiator 54. Each of the common radiators 52, 54, 56 can be referred to as a radiator, a liquid-to-air radiator, a heat exchanger or a liquid-to-air heat exchanger.

The main housing 12 can include an inlet that is bound by a top edge of the front access panel 13, the leading edges of the upper access panels 18L, 18R and the bottom edge of the top panel 19. The radiators 52, 54 56 can be in fluid communication with the inlet such that ambient air that enters the inlet can flow through the radiators 52, 54, 56.

The top panel 19 can include a plurality of louvered openings 66 that form an outlet for the ambient to exit the heat exchanger compartment 28 after flowing through the radiators 52, 54, 56. Some of the louvers 66 are not indicated with a reference number in FIG. 2 for clarity and simplicity of the drawing.

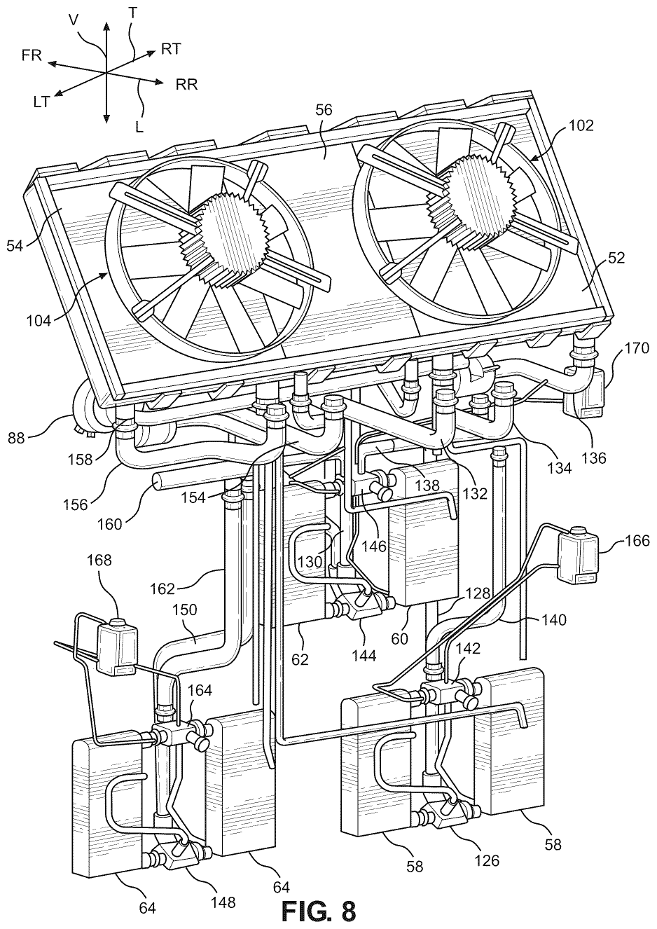

Referring to FIGS. 2, 3, 7 and 8 collectively, the plurality of heat exchangers 58, 60, 62, 64 can include a first pair of heat exchangers 58, a second pair of heat exchangers 60, 62 and a third pair of heat exchangers 64. Each of the heat exchangers 58, 60, 62, 64 can be referred to as a liquid-to-liquid heat exchanger. Each of the heat exchangers 58, 60, 62, 64 can be any appropriate type of heat exchanger such as, but not limited to, a brazed plate heat exchanger. The heat exchangers 58, 60 62, 64 can be fabricated from AISI grade 316 stainless steel to minimize ion leaching.

The heat exchangers 58, 60, 62 64 can be adjacent to the front panel 13 and can be located between the front panel 13 and the fuel cell units 40, 42, 44 in the longitudinal direction L of the vehicle 1. The fuel cell units 40, 42, 44 are omitted from FIGS. 2, 7 and 8 for clarity and simplicity of the drawings.

The first fuel cell unit 40 can be positioned in the fuel cell compartment 26 at a location that is adjacent to the first pair of heat exchangers 58, the second fuel cell unit 42 can be positioned in the fuel cell compartment 26 at a location that is adjacent to the second pair of heat exchangers 60, 62, and the third fuel cell unit 44 can be positioned in the fuel cell compartment 26 at a location that is adjacent to the third pair of heat exchangers 64. That is, the first and third fuel cell units 40, 44 can be located side-by-side in the transverse direction T of the vehicle 1 and the second fuel cell unit 42 unit can be stacked above the first and third fuel cell units 40, 44 in the vertical direction V of the vehicle 1 and overlap the first and third fuel cell units 40, 44 in the transverse direction T and the longitudinal direction L of the vehicle 1.

Referring to FIG. 4, each of the fuel cell units 40, 42, 44 can include a coolant pump 66 and a compressor power invertor module (CPIM) 68. Only the pump 66 and the CPIM 68 for the third fuel cell unit 44 are indicated in FIG. 4 for clarity and simplicity of the drawing.

The fuel cell compartment 26 can be closed to fluid communication with the ambient air that is outside of the vehicle 1. Thus, the heat exchangers 58, 60, 62 64 cannot dissipate the waste heat from the fuel cell stacks 46 directly to the ambient air. The system 50 can be configured to transfer the heat absorbed by the heat exchangers 58, 60, 62 64 to other components of the system 50 can be in fluid communication with the ambient air that is outside of the vehicle 1.

The system 50 can include a plurality of isolation cooling circuits, a plurality of high temperature cooling circuits, and a low temperature cooling circuit. Fluid flowing in the high temperature cooling circuits and the low temperature cooling circuits can be isolated from the fluid (i.e., isolation coolant) flowing in the isolation cooling circuits, thereby reducing or minimizing adverse effect(s) of ion leaching in the isolation coolant. The heat exchangers 58, 60, 62, 64 can be common to a respective one of the isolation cooling circuits and a respective one of the high temperature cooling circuits. Thus, the fluid flowing in the high temperature cooling circuits can be thermally coupled to the isolation coolant flowing in the isolation cooling circuits, and waste heat produced by the fuel cell stacks 46 can be transferred to the ambient air that is outside of the vehicle 1.

The first isolation cooling circuit can include the fuel cell stack 46, the coolant pump 66 and the CPIM 68 of the first fuel cell unit 40, the first pair of heat exchangers 58, and the conduit(s) and connection(s) that provide fluid communication between the first fuel cell unit 40 and the first pair of heat exchangers 58. Isolation coolant can flow through the first isolation circuit in the direction indicated by the dotted arrows in FIG. 4 extending between the first fuel cell unit 40 and the first pair of heat exchangers 58.

Each of the heat exchangers 58 can be connected to the first fuel cell unit 40 in parallel fluid communication. Although not shown in the drawings, the first isolation cooling circuit can include an inlet manifold that combines the isolation coolant from each of the first pair of heat exchangers 58 into a single input that is in fluid communication with the coolant pump 66. In alternate embodiments, the coolant pump 66 can include two inlets-one for each of the heat exchangers 58. Also not shown in the drawings, the first isolation cooling circuit can include a second manifold that splits the isolation coolant exiting from the first fuel cell unit 40 into a pair of input lines that are each in fluid communication with a respective one of the heat exchangers 58. In alternate embodiments, the first fuel cell unit 40 can include two outlets-one for each of the heat exchangers 58.

The second isolation cooling circuit can include the fuel cell stack 46, the coolant pump 66 and the CPIM 68 of the second fuel cell unit 42, the second pair of heat exchangers 60, 62, and the conduit(s) and connection(s) that provide fluid communication between the second fuel cell unit 42 and the second pair of heat exchangers 60, 62. The second isolation cooling circuit can be arranged in the same manner or a similar manner as described above with respect to the first isolation circuit with the third and fourth heat exchangers 60, 62 connected in parallel fluid communication with the second fuel cell unit 42.

The third isolation cooling circuit can include the fuel cell stack 46, the coolant pump 66 and the CPIM 68 of the third fuel cell unit 44, the third pair of heat exchangers 64, and the conduit(s) and connection(s) that provide fluid communication between the third fuel cell unit 44 and the third pair of heat exchangers 64. The third isolation cooling circuit can be arranged in the same manner or a similar manner as described above with respect to the first isolation circuit with the heat exchangers 64 connected in parallel fluid communication with the third fuel cell unit 44.

The first high temperature cooling circuit can include the first pair of heat exchangers 58, the third heat exchanger 60, a first manifold 70, a first load resistor 72, the first radiator 52, a first pump 74, a second manifold 76 and the conduit(s) and connection(s) that provide fluid communication between the first pair of heat exchangers 58, the third heat exchanger 60, the first manifold 70, the first load resistor 72, the first radiator 52, the first pump 74 and the second manifold 76. Coolant can flow through the first high temperature cooling circuit as indicated by the arrows between each of the first pair of heat exchangers 58, the third heat exchanger 60, the first manifold 70, the first load resistor 72, the first radiator 52, the first pump 74 and the second manifold 76.

The coolant flowing through in the first high temperature cooling circuit can include regular water that is not de-ionized because the coolant flowing through the first high temperature cooling circuit does not flow into any of the fuel cell units 40, 42, 44. Thus, ions leaching from any components of the first high temperature cooling circuit can be isolated from the fuel cell units 40, 42, 44. Further, by sharing the first pair of heat exchangers 58 with the first isolation cooling circuit and sharing the third heat exchanger 60 with the second isolation cooling circuit, waste heat produced by the fuel cell stacks 46 of the first fuel cell unit 40 and the second fuel cell unit 42 can be exhausted to the ambient air via the first radiator 52.

The first manifold 70 can be downstream from the first pair of heat exchangers 58 and the third heat exchanger 60 and in fluid communication with the first pair of heat exchangers 58 and the third heat exchanger 60. The heat exchangers 58, 60 can be connected to the first manifold 70 in parallel with each other. The first manifold 70 can be upstream of the first load resistor 72 and in fluid communication with the first load resistor 72.

The first load resistor 72 can be downstream from the first manifold 70 and in fluid communication with the first manifold 70. The first load resistor 72 can be in fluid communication with the first pair of heat exchanger 58 and the third heat exchanger 60 via the first manifold 70. The first load resistor 72 can be upstream of the first radiator 52 and in fluid communication with the first radiator 52.

The first radiator 52 can be downstream from the load resistor 72 and in fluid communication with the load resistor 72. The first radiator 52 can be upstream of the first pump 74 and in fluid communication with the first pump 74.

The first pump 74 can be downstream from the first radiator 52 and in fluid communication with the first radiator 52. The first pump 74 can be upstream of the second manifold 76 and in fluid communication with the second manifold 76. The first pump 74 can be in fluid communication with the first pair of heat exchangers 58 and the third heat exchanger 60 via the second manifold 76.

The second manifold 76 can be downstream from the first pump 74 and in fluid communication with the first pump 74. The second manifold 76 can be upstream of the first pair of heat exchangers 58 and the third heat exchanger 60 and in fluid communication with the first pair of heat exchangers 58 and the third heat exchanger 60. The heat exchangers 58, 60 can be connected to the second manifold 76 in parallel with each other.

The second high temperature cooling circuit can include the fourth heat exchanger 62, the third pair of heat exchangers 64, a third manifold 78, a second load resistor 80, the second radiator 54, a second pump 82, a fourth manifold 84 and the conduit(s) and connection(s) that provide fluid communication between the fourth heat exchanger 62, the third pair of heat exchangers 64, the third manifold 78, the second load resistor 80, the second radiator 54 and the second pump 82 and the fourth manifold 84. Coolant can flow through the second high temperature cooling circuit as indicated by the arrows between each of the third pair of heat exchangers 64, the fourth heat exchanger 62, the third manifold 78, the second load resistor 80, the second radiator 54, the second pump 82 and the fourth manifold 84.

The coolant flowing through the second high temperature cooling circuit can include regular water that is not de-ionized because the coolant flowing through the first high temperature cooling circuit does not flow into any of the fuel cell units 40, 42, 44. Thus, ions leaching from any components of the first high temperature cooling circuit can be isolated from the fuel cell units 40, 42, 44. Further, by sharing the third pair of heat exchangers 64 with the third isolation cooling circuit and sharing the fourth heat exchanger 62 with the second isolation cooling circuit, waste heat produced by the fuel cell stacks 46 of the second fuel cell unit 42 and the third fuel cell unit 44 can be exhausted to the ambient air via the second radiator 54. That is, the waste heat emitted by the fuel cell stack 46 of the second fuel cell unit 42 can be distributed to each of the first radiator 52 and the second radiator 54.

The third manifold 78 can be downstream from the third pair of heat exchangers 64 and the fourth heat exchanger 62 and in fluid communication with the third pair of heat exchangers 64 and the fourth heat exchanger 62. The heat exchangers 62, 64 can be connected to the third manifold 78 in parallel with each other. The third manifold 78 can be upstream of the second load resistor 80 and in fluid communication with the second load resistor 80.

The second load resistor 80 can be downstream from the third manifold 78 and in fluid communication with the third manifold 78. The second load resistor 80 can be in fluid communication with the third pair of heat exchangers 64 and the fourth heat exchanger 62 via the third manifold 78. The second load resistor 80 can be upstream of the second radiator 54 and in fluid communication with the second radiator 54.

The second radiator 54 can be downstream from the second load resistor 80 and in fluid communication with the second load resistor 80. The second radiator 54 can be upstream of the second pump 82 and in fluid communication with the second pump 82.

The second pump 82 can be downstream from the second radiator 54 and in fluid communication with the second radiator 54. The second pump 82 can be upstream of the fourth manifold 84 and in fluid communication with the fourth manifold 84. The second pump 82 can be in fluid communication with the third pair of heat exchangers 64 and the fourth heat exchanger 62 via the fourth manifold 84.

The fourth manifold 84 can be downstream from the second pump 82 and in fluid communication with the second pump 82. The fourth manifold 84 can be upstream of the third pair of heat exchangers 64 and the third heat exchanger 62 and in fluid communication with the third pair of heat exchangers 64 and the third heat exchanger 62.

In summary, the first pair of heat exchangers 58 and the third heat exchanger 60 can be referred to as a heat source for the first high temperature cooling circuit. The third pair of heat exchangers 64 and the fourth heat exchanger 62 can be referred to as a heat source for the second high temperature cooling circuit.

The low temperature cooling circuit can include the BoP 48 of each of the fuel cell units 40, 42, 44, an outbound manifold 86, the third radiator 56, a third pump 88, an inbound manifold 90, a brake chopper 92, a first DC/DC converter 94 and a second DC/DC converter 96. The brake chopper 92 and the DC/DC inverters 94, 96 can be referred to collectively as a heat source 92, 94, 96. Coolant can flow through the low temperature cooling circuit as indicated by the arrows between each of the BoPs 48, the outbound manifold 86, the third radiator 56, the third pump 88, the inbound manifold 90, the brake chopper 92, the first DC/DC converter 94 and the second DC/DC converter 96.

Coolant flowing through each of the BoPs 48 can be isolated from the fuel cell stacks 46. Thus, the system 50 can avoid adverse risks to the fuel cell stacks 46 due to ion leaching in the low temperature cooling circuit. The coolant flowing in the low temperature cooling circuit can include glycol and regular water that is not de-ionized.

The heat source 92, 94, 96 and the BoPs 48 of all of the fuel cell units 40, 42, 44 can be connected in parallel to the outbound manifold 86, located upstream of the outbound manifold 86, and in fluid communication with the outbound manifold 86. The heat source 92, 94, 96 and the BoPs 48 of all of the fuel cell units 40, 42, 44 can be connected in parallel to the inbound manifold 90, located downstream of the inbound manifold 90, and in fluid communication with the inbound manifold 90.

The outbound manifold 86 can be downstream from and in fluid communication with each of the heat source 92, 94, 96 and the BoPs 48. The outbound manifold 86 can be upstream from and in fluid communication with the third radiator 56.

The third radiator 56 can be downstream from and in fluid communication with the outbound manifold 86. The third radiator 56 can be in fluid communication with all of the BoPs 48 via the outbound manifold 86. The third radiator 56 can be upstream from and in fluid communication with the third pump 88.

The third pump 88 can be downstream from and in fluid communication with the third radiator 56. The third pump 88 can be upstream from and in fluid communication with the inbound manifold 90. The third pump 88 can be in fluid communication with all of the heat source 92, 94, 96 and the BoPs 48 via the inbound manifold 90.

The inbound manifold 90 can be downstream from and in fluid communication with the third pump 88. The inbound manifold 90 can be upstream from and in fluid communication with all of the heat source 92, 94, 96 and the BoPs 48.

The heat source 92, 94, 96 can be downstream from and in fluid communication with the inbound manifold 90. The brake chopper 92 and the DC/DC inverters 94, 96 can be connected in series with each other in the low temperature cooling circuit and between the inbound manifold 90 and the outbound manifold 86.

The brake chopper 92 can be downstream from and in fluid communication with the inbound manifold 90. The first brake chopper 92 can be upstream from and in fluid communication with the first DC/DC converter 94.

The first DC/DC converter 94 can be downstream from and in fluid communication with the brake chopper 92. The first DC/DC converter 94 can be upstream from and in fluid communication with the second DC/DC converter 96.

The second DC/DC converter 96 can be downstream from and in fluid communication with the first DC/DC converter 94. The second DC/DC converter 96 can be upstream from and in fluid communication with the outbound manifold 86.

Referring to FIG. 5, the electric vehicle 1 can include a thermal circuit 98 for the battery pack 15. The thermal circuit 98 can include a heater 100, a chiller 102 and conduit(s) and connection(s) that fluidly couple the battery pack 15 to each of the heater 100 and the chiller 102. The heater 100 can be an electric heater that is configured to selectively heat the fluid flowing through the battery pack 15 and the chiller 102 can be a heat exchanger that is configured to cool the fluid flowing through the battery pack 15.

The pumps 74, 82, 88 can be any appropriate pump such as, but not limited to, an electric pump. Each of the pumps 74, 82, 88 can be a variable speed pump and the speed can be adjusted to vary the flow rate of coolant flowing through the respective cooling circuit.

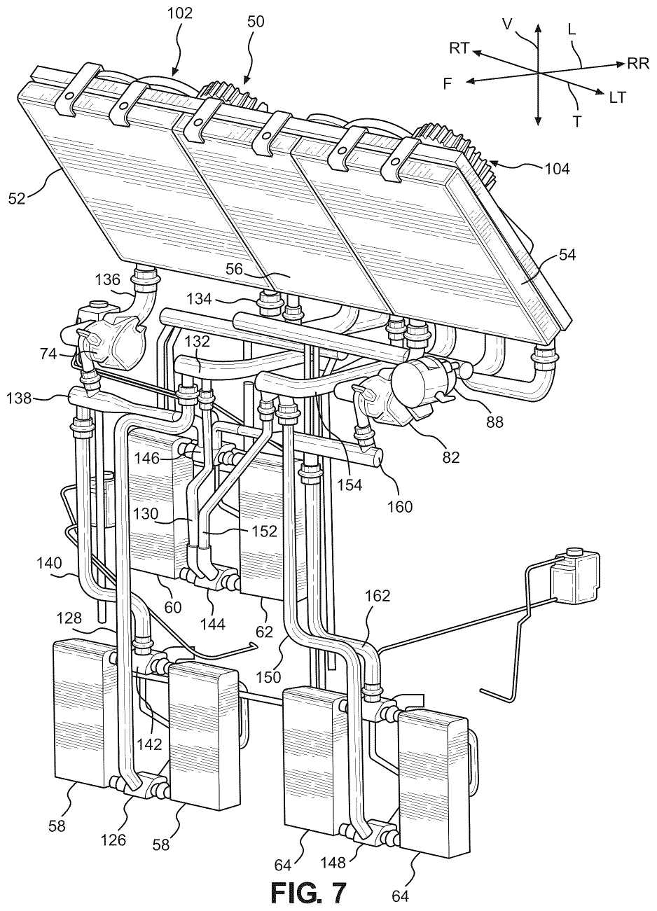

Referring to FIGS. 7-9, the system 50 can include a plurality of fans 104, 106. The first fan 104 can overlap the first radiator 52 and the third radiator 56 be configured draw ambient air through the opening in the main housing 12 and into the first and third radiators 52, 56. The second fan 106 can overlap the second radiator 54 and the third radiator 56 and be configured to draw ambient air through the opening in the main housing 12 and into the second and third radiators 54, 56. Each of the fans 104, 106 can include an electric motor. Each of the fans 104, 106 can be a variable speed fan and the speed can be adjusted to vary the flow rate of ambient air flowing through the radiators 52, 54, 56.

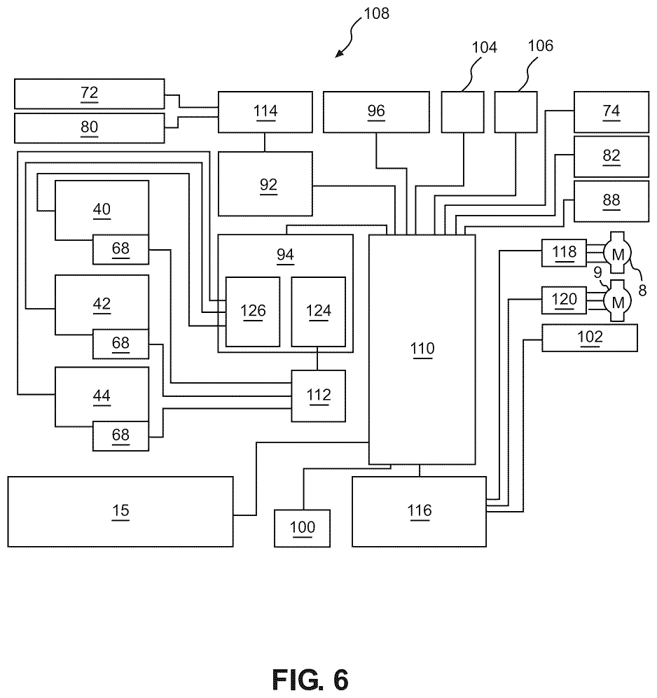

Referring to FIG. 6, the vehicle 1 can include a power distribution system 108 that can receive electric power generated by the fuel cell units 40, 42, 44 and supply the electric power to the electric motors 8, 9, the battery pack 15, the pumps 74, 84, 88, the load resistors 72, 80, the heater 100, the chiller 102, and the fans 104, 106 The power distribution system 108 can include the fuel cell units 40, 42, 44, the brake chopper 92, the DC/DC converters 94, 96, a main power distribution unit (main PDU) 110, an inverter splitter 112, a resistor splitter 114 and a secondary power distribution unit (secondary PDU) 116.

The first DC/DC converter 94 can be electrically connected to (i.e., in electrical communication with) the fuel cell stack 46 of each of the fuel cell units 40, 42, 44, the main PDU 110 and the inverter splitter 112. DC/DC converter 94 can include a first bus 122 that is electrically connected to the fuel cell stacks 46 and a second bus 124 that is electrically connected to the inverter splitter 112. The first DC/DC converter 94 can be configured to receive a predetermined input voltage from each of the fuel cell units 40, 42, 44 and convert the input voltage to a first output voltage that is greater than the input voltage and a second output voltage that is less than the input voltage. The first DC/DC converter 94 can output the first output voltage to the main PDU 110 and output the second output voltage to the inverter splitter 112 via the second bus 124. The first DC/DC converter 94 can also be referred to as a high voltage to high voltage converter or as a HV/HV converter.

The main PDU 110 can be electrically connected to (i.e., in electrical communication with) each of the battery pack 15, the pumps 74, 82, 88, the brake chopper 92, the second DC/DC converter 96, the heater 100, the fans 104, 106 and the secondary PDU 116. The main PDU 110 can include any appropriate structure(s) and/or system(s) that can receive the first output voltage from the first DC/DC converter 94. Exemplary embodiments of the main PDU 110 can include a controller that is configured with software and/or hardware to selectively distribute the electric power generated by the fuel cell stacks 46 to/from the battery pack 15 based on the state of charge of the battery pack 15 and the real-time power demand for each of the electric motors 8, 9, and the pumps 74, 82, 88, the fans 104 106.

The main PDU 110 can be configured to output the first output voltage to each of the pumps 74, 82, 88 and the fans 104, 106. The pumps 74, 82, 88 and the fans 104, 106 can also be referred to as high voltage pumps and high voltage fans, respectively.

Under certain circumstances, it is possible that the electric power generated by the fuel cell stack(s) 46 and/or the electrical regenerative power output by the electric motors 8, 9 during deceleration of the vehicle 1 can exceed a desired charging power for charging the battery pack 15. Thus, it can be desirable to efficiently route this excess electric power away from the battery pack 15. The load resistors 72, 80 can receive this excess electric power and convert the excess electric power into heat.

For example, one or both of the load resistors 72, 80 can provide electric braking by converting regenerative electric power produced by one or both of the electric motors 8, 9 into heat. The electrical resistance of the load resistor(s) 72, 80 can slow the rotation of the electric motor(s) 8, 9, thereby braking travel motion of the vehicle 1.

In another operational example, the fuel cell stacks 46 can generate a tip-out power that might be incompatible with the desired charging power. One or both of the load resistors 72, 80 can convert the tip-out power into heat so that the battery pack 15 can be protected against overcharging and/or an undesirable charging rate.

The main PDU 110 can be configured to divert the excess electric power to the brake chopper 92. The brake chopper 92 can be any appropriate structure such as, but not limited to, a magnetic switch that automatically activates when the excess voltage exceeds a predetermined threshold. When activated, the brake chopper 92 can output a chopped power to the resistor splitter 114. The resistor splitter 114 can be configured to supply the chopped power to each of the load resistors 72, 80. The resistor splitter can be configured to equally or unequally supply the chopped power to the load resistors 72, 80.

The load resistors 72, 80 can be configured to transfer the generated heat into the coolant flowing through the respective one of the resistors 72, 80. Thus, the excess electric power can be dissipated into the ambient environment via the respective one or both of the first and second radiators 52, 54.

The second DC/DC converter 96 can be electrically connected to (i.e., in electrical communication with) the main PDU 110. The second DC/DC converter 96 can be configured to convert the first high voltage to a low voltage. The second DC/DC converter 96 can be referred to as a high voltage to low voltage converter or as a HV/LV converter.

The secondary PDU 116 can be electrically connected to (i.e., in electrical communication with) the main PDU 110. The secondary PDU 116 can include any appropriate structure(s) and/or system(s) that can receive the first output voltage from the main PDU 110 and distribute electric power to a first inverter 118, a second inverter 120 and the chiller 102, as needed. The inverters 118, 120 can be any appropriate structure(s) that can convert the DC power to AC power and supply the AC power to a respective one of the electric motors 8, 9.

Each of the first and third manifolds 70, 78 of FIG. 4 can include three inputs and one output and each of the second and fourth manifolds 76, 84 can include one input and three outputs. However, exemplary embodiments can include any appropriate plumbing fixtures that can couple the first pair of the heat exchangers 58, and the third heat exchanger 60 with the first radiator 52 and couple the third pair of exchangers 64 and the fourth heat exchanger 62 with the second radiator 54.

For example, in the system 50 shown in FIGS. 3, 7 and 8 the first high temperature cooling circuit can include a first HE manifold 126, a first supply conduit 128, a first HE conduit 130, a first intermediate manifold 132, a first inlet conduit 134, a first outlet conduit 136, a second intermediate manifold 138, a first return conduit 140, a second HE manifold 142 and a first connector 144. The second high temperature cooling circuit can include a third HE manifold 148, a second supply conduit 150, a second HE conduit 152, a third intermediate manifold 154, a second inlet conduit 156, a second outlet conduit 158, a fourth intermediate manifold 160, a second return conduit 162, a fourth HE manifold 164 and a second connector 146.

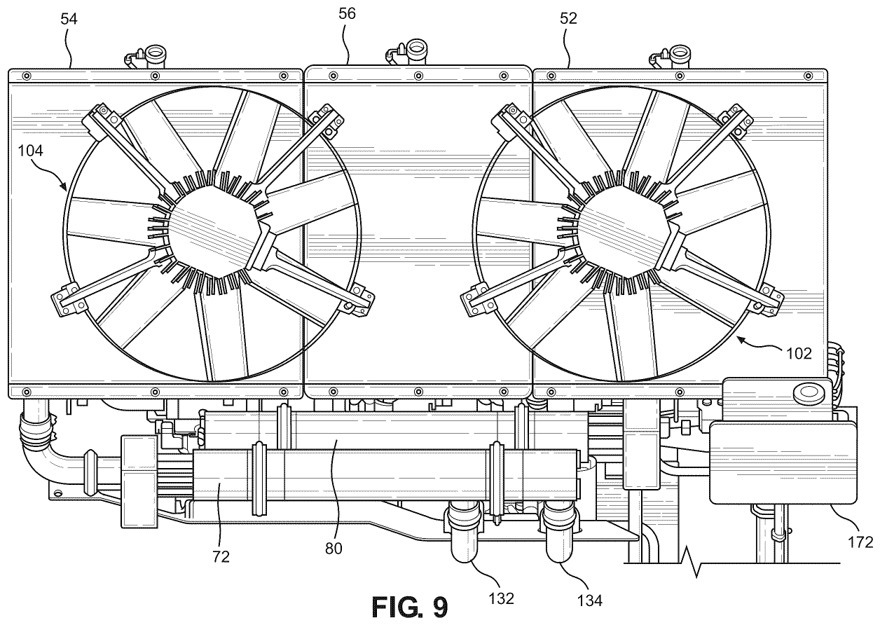

Instead of connecting all three heat exchangers 58, 60 with the first manifold 70, the first HE manifold 126 can connect the first pair of heat exchangers 58 to the first supply conduit 128. The first intermediate manifold 132 can connect the first supply conduit 128 and the HE conduit 130 to first radiator 52 via first load resistor 72 (see FIG. 9) and the load inlet conduit 134. The load resistors 72, 80 are omitted from FIGS. 3, 7 and 8 for clarity and simplicity of the drawings. The first outlet conduit 136 can connect the first radiator 52 to the first pump 74 and the second intermediate manifold 138 can connect the first pump 74 to each of the return conduit 140 and the second connector 146.

The second high temperature cooling circuit 146, 148, 150, 152, 154, 156, 158, 160, 162, 164 can be connected and in fluid communication as described above with respect to the first high temperature cooling circuit 126, 128, 130, 132, 134, 136, 138, 140, 142, 144, and the second load resistor 80 (FIG. 9) can be connected to the third intermediate manifold 154 and the second inlet conduit 156.

The system 50 can include a plurality of expansion tanks 166, 168, 170. The first expansion tank 166 can be in fluid communication with the first isolation cooling circuit, the second expansion tank 168 can be in fluid communication with the second isolation cooling circuit, the third expansion tank 170 can be in fluid communication with the third isolation cooling circuit. This arrangement can prevent the transfer of ions between the isolation cooling circuits.

The system 50 can include a fourth expansion tank 172 that is in fluid communication with each of the radiators 52, 54, 56.

In summary, the system 50 can provide a unified cooling system capable of rejecting the heat output of three fuel cell units 40, 42, 44 as well as implementation related hardware through three common radiators 52, 54, 56. The AISI grade 316 stainless steel brazed plate heat exchangers 58, 60, 62, 64 and cooling connections made with AISI grade 316 stainless steel and high purity silicone can allow for heat transfer out of the isolation coolant without introducing ion leaching materials that pose risks to isolation coolant conductivity. The load resistors 72, 80 can provide electric braking in the form of heat generation to dissipate regeneration electricity from the electric motors 8, 9 and tip-out power from fuel cell units 40, 42, 44 that cannot be accepted by the battery pack 15. The first and second high voltage pumps 74, 82 can circulate cooling on the radiator side of the two high temperature cooling circuits, circulating coolant between the respective brazed plate heat exchangers 58, 60, 62, 64, a respective one of the load resistors 72, 80, and a respective one of the radiators 52, 54. The low temperature cooling circuit (which interfaces with the BoPs 48) can be operated by the third high voltage pump 88. The radiators 52, 54, 56 can be cooled by the high voltage radiator fans 104, 106, which are capable of flowing enough air to reject a maximum thermal load at maximum rated ambient temperature and 0 m/s vehicle speed.

While certain embodiments of the invention are described above, it should be understood that the invention can be embodied and configured in many different ways without departing from the spirit and scope of the invention.

Instead of the six heat exchangers 58, 60, 62, 64, alternate embodiments can include a respective single heat exchanger for each of the fuel cell units, and one of the heat exchangers can be in fluid communication with the each of the first radiator 52 and the second radiator 54 by a pair of manifolds. Thus, a total number of the heat exchangers and a total number of the manifolds for the two high temperature cooling circuits can be reduced by half.

Instead of AISI grade 316 stainless steel, the heat exchangers 58, 60, 62, 64 and other structures of the system 50 can be fabricated from any appropriate material the will not leach ions into the coolant or at most allows a concentration of ions in the coolant that is less than a desired amount.

The electric vehicle 1 is described in the context of a commercial transport vehicle. However, the disclosed main power system 10 can be used with any electric vehicle that is configured for travel along any one or combination of improved, unimproved, and unmarked paths. For example, embodiments are intended to include or otherwise cover any type of vehicle, including a passenger car, a minivan, a sport-utility vehicle, a crossover vehicle, a bus, an off-highway vehicle, a construction vehicle, a locomotive, a truck without a trailer, etc.

The electric vehicle 1 described above can include three fuel cell units 40, 42, 44. However, alternate embodiments can include less than three or more than three fuel cell units 40, 42, 44.

The FCS 22 can include any currently known or future-developed fuel cell structure(s). Alternate embodiments of the fuel cell can include any appropriate chemical reaction(s) that produces electrons that can be stored in a battery, capacitor or any other known of future developed electron storage device.

Instead of two electric motors 8, 9, alternate embodiments of the electric vehicle 1 can include one electric motor or more than two electric motors. Each electric motor can be directly coupled to a respective wheel or pair of wheels. In alternate, embodiments, a geartrain can transfer the output by the electric motor(s) to the respective wheel(s).

What is claimed is:

1. An indirect thermal management system for an electric vehicle including a plurality of fuel cell units, at least one electric motor and a high voltage battery system, the indirect thermal management system comprising:
a plurality of heat exchangers configured to be in fluid communication with and absorb heat produced by the fuel cell units;
a plurality of load resistors, each of the load resistors is in fluid communication with at least a respective one of the heat exchangers;
a plurality of common radiators, each of the common radiators is in fluid communication with a respective one of the load resistors; and
a plurality of high voltage pumps, each of the high voltage pumps is in fluid communication with a respective one of the common radiators and configured to circulate coolant among at least a respective one of the heat exchangers, the respective one of the common radiators, and a respective one of the load resistors.

2. The indirect thermal management system according to claim 1, wherein the load resistors are configured to:
be in electrical communication with the electric motor and the fuel cell units;
convert electrical energy into heat, the electrical energy is generated by the electric motor if the electric vehicle is decelerating; and
convert tip-out electrical energy into heat, the tip-out electrical energy is electrical energy output by the fuel cell units that exceeds a real-time capacity of the high voltage battery system.

3. The indirect thermal management system according to claim 1, further comprising:
a plurality of fluid conduits, each of the fluid conduits is connected to a respective one of the heat exchangers, and each of the fluid conduits is fabricated from AISI grade 316 stainless steel and a predetermined amount of silicone such that ion leaching materials are isolated from coolant flowing through the fuel cell units.

4. The indirect thermal management system according to claim 1, wherein
the plurality of heat exchangers include a plurality of brazed plate heat exchangers including a first heat exchanger, a second heat exchanger, and a third heat exchanger, each of the first heat exchanger, the second heat exchanger, and third heat exchanger is configured to be in fluid communication with a fuel cell stack of a respective one of the fuel cell units,
the plurality of radiators include:
a first radiator in fluid communication with the first heat exchanger and the third heat exchanger,
a second radiator in fluid communication with the second heat exchanger, and
a third radiator configured to be in fluid communication with a balance of plant of each of the fuel cell units.

5. The indirect thermal management system according to claim 4, wherein
the plurality of high voltage pumps include:
a first pump in fluid communication with the first radiator, the first heat exchanger, and the third heat exchanger; and
a second pump in fluid communication with the second heat exchanger and the second radiator.

6. The indirect thermal management system according to claim 5, wherein the plurality of high voltage pumps include a third pump in fluid communication with the third radiator and configured to be in fluid communication with the balance of plant of each of the fuel cell units.

7. The indirect thermal management system according to claim 4, further comprising:
a first high voltage fan adjacent to the first radiator and configured to draw an airflow through the first radiator; and
a second high voltage fan adjacent to the second radiator and configured to draw an airflow through the second radiator.

8. The indirect thermal management system according to claim 4, wherein
the first radiator, the second radiator, and the third radiator are arrayed side-by-side, and
the first fan and the second fan overlap the third radiator.

9. An indirect thermal management system for an electric vehicle including a battery pack, at least one driven wheel, and at least one electric motor in electrical communication with the battery pack and configured to drive the driven wheel, the indirect thermal management system comprising:
a first fuel cell unit that includes a fuel cell stack and a balance of plant;
a first heat exchanger in fluid communication with the fuel cell stack and isolated from the balance of plant; and
a first high temperature cooling circuit that is isolated from the first fuel cell unit such that coolant flowing through the fuel cell stack of the first fuel cell unit is isolated from coolant flowing through the first high temperature cooling circuit, the first high temperature cooling circuit includes:
a first load resistor in fluid communication with the first heat exchanger, the first load resistor is configured to convert electrical energy into heat;
a first radiator in fluid communication with the first load resistor, the first radiator is configured to be in fluid communication with ambient air outside of the electric vehicle; and
a first pump in fluid communication with the first radiator and the first heat exchanger, and configured to circulate coolant among the first heat exchanger, the first load resistor, and the first radiator.

10. The indirect thermal management system according to claim 9, further comprising:
a second heat exchanger in fluid communication with the fuel cell stack of the first fuel cell unit and isolated from the balance-of plant of the first fuel cell unit;
a first manifold in fluid communication with the first pump, the first heat exchanger, and the second heat exchanger; and
a second manifold in fluid communication with the first heat exchanger, the second heat exchanger, and the first load resistor.

11. The indirect thermal management system according to claim 10, further comprising:
a second fuel cell unit that includes a fuel cell stack and a balance-of-plant;
a third heat exchanger and a fourth heat exchanger, both of the third heat exchanger and a fourth heat exchanger are in fluid communication with the fuel cell stack of the second fuel cell unit, both of the third heat exchanger and a fourth heat exchanger are isolated from the balance-of plant of the second fuel cell unit; and
a second high temperature cooling circuit that is isolated from the second fuel cell unit such that coolant flowing through the fuel cell stack of the second fuel cell unit is isolated from coolant flowing through the second high temperature cooling circuit, the second high temperature cooling circuit includes:
a second load resistor in fluid communication with the fourth heat exchanger, the second load resistor is configured to convert electrical energy into heat;
a second radiator in fluid communication with the second load resistor, the second radiator is configured to be in fluid communication with ambient air outside of the electric vehicle; and
a second pump in fluid communication with the second radiator and the fourth heat exchanger, the second pump is configured to circulate coolant among the fourth heat exchanger, the second load resistor, and the second radiator, wherein
the third heat exchanger is in fluid communication with the first brake resistor, the first manifold, and the second manifold.

12. The indirect thermal management system according to claim 9, further comprising:
a low temperature cooling circuit that is isolated from the fuel cell stack of the first fuel cell unit such that coolant flowing through the fuel cell stack of the first fuel cell unit is isolated from coolant flowing through the low temperature cooling circuit, the low temperature cooling circuit is in fluid communication with the balance of plant of the first fuel cell unit, and includes:
a low temperature pump configured to be in fluid communication with the balance-of-plant; and
a low temperature radiator in fluid communication with the low temperature pump and configured to be in fluid communication with the balance-of-plant.

13. The indirect thermal management system according to claim 12, further comprising:
at least one DC/DC voltage converter in electrical communication with the fuel cell stack and configured to be in electrical communication with the battery pack, the DC/DC voltage converter is in fluid communication with the low temperature radiator; and
a brake chopper in electrical communication with the first load resistor and at least one of the electric motor and the fuel cell stack of first fuel cell unit, the brake chopper is in fluid communication with the low temperature pump, wherein
the electric energy converted by the first load resistor is output by the brake chopper.

14. The indirect thermal management system according to claim 12, further comprising:
a second fuel cell unit that includes a fuel cell stack and a balance-of-plant, wherein
the low temperature cooling circuit is isolated from the fuel cell stack of the second fuel cell unit such that coolant flowing through the fuel cell stack of the second fuel cell unit is isolated from coolant flowing through the low temperature cooling circuit, the low temperature cooling circuit is in fluid communication with a balance-of-plant of the second fuel cell unit.

15. An indirect thermal management system for an electric vehicle including a battery pack, at least one driven wheel, and at least one electric motor in electrical communication with the battery pack and configured to drive the driven wheel, the indirect thermal management system comprising:
a first fuel cell unit that includes a first fuel cell stack and a first balance of plant;
a second fuel cell unit that includes a second fuel cell stack and a second balance of plant;
a third fuel cell unit that includes a third fuel cell stack and a third balance of plant;
a plurality of heat exchangers configured to be in fluid communication with and absorb heat produced by the first fuel cell stack, the second fuel cell stack, and the third fuel cell stack;
a plurality of load resistors, each of the load resistors is in fluid communication with at least a respective one of the heat exchangers;
a plurality of radiators, each of the radiators is in fluid communication with a respective one of the load resistors; and
a plurality of high voltage pumps, each of the high voltage pumps is in fluid communication with a respective one of the radiators and is configured to circulate coolant among at least a respective one of the heat exchangers, the respective one of the radiators, and a respective one of the load resistors.

16. The indirect thermal management system according to claim 15, wherein the plurality of heat exchangers includes:
a first pair of heat exchangers in fluid communication with the first fuel cell stack;
a second pair of heat exchangers in fluid communication with the second fuel cell stack; and
a third pair of heat exchangers in fluid communication with the third fuel cell stack.

17. The indirect thermal management system according to claim 16, wherein
the second pair of heat exchangers includes a first heat exchanger and a second heat exchanger,
the plurality of radiators includes:
a first radiator in fluid communication with the first pair of heat exchangers and the first heat exchanger; and
a second radiator in fluid communication with the third pair of heat exchangers and the second heat exchanger.

18. The indirect thermal management system according to claim 17, wherein the plurality of radiators includes a third radiator in fluid communication with the first balance-of-plant, the second balance-of-plant, and the third balance-of-plant.

19. The indirect thermal management system according to claim 18, further comprising:
a first manifold in fluid communication with the first balance of plant, the second balance of plant, the third balance of plant, and the third radiator; and
a second manifold in fluid communication with the first balance of plant, the second balance of plant, and the third balance of plant,
wherein the plurality of high voltage pumps includes:
a first pump in fluid communication with the first radiator, the first pair of heat exchangers and the first heat exchanger;
a second pump in fluid communication with the second radiator and the second pair of heat exchangers, and the second heat exchanger; and
a third pump in fluid communication with the third radiator and the second manifold.

20. An electric vehicle comprising:
the indirect thermal management system according to claim 19;
a chassis extending in a longitudinal direction and a transverse direction;
a plurality of wheels suspended from the chassis;
at least one electric motor connected to at least one of the wheels and configured to drive the at least one of the wheels;
a battery pack in electrical communication with the first fuel cell, the second fuel cell, the third fuel cell, and the electric motor;
a cab mounted on the chassis and extending away from the chassis in a vertical direction;
a fuel cell compartment connected on the chassis and located adjacent to the cab, the fuel cell compartment is closed to fluid communication with ambient air outside of the electric vehicle; and
a heat exchanger compartment connected to the chassis and located adjacent to the cab, the heat exchanger compartment is in fluid communication with the ambient air outside of the electric vehicle, wherein
the first radiator, the second radiator, and the third radiator are located in the heat exchanger compartment, and
the first fuel cell unit, the second fuel cell unit, and the third fuel cell unit, the first pair of heat exchangers, the second pair of heat exchangers, and the third pair of heat exchangers are located on the fuel cell compartment.
